(19) United States
(12) Patent Application Publication
(10) Pub. No.: US 2006/0118311 A1
(43) Pub. Date: Jun. 8, 2006

(54) Composite horseshoe and method of manufacture

(76) Inventors: Samuel M. Serritella, Garfield, NJ (US); Gary P. Kouletas, Lodi, NJ (US)

Correspondence Address: GEORGE PAPPAS, SUITE 300, 919 S. HARRISON STREET, FORT WAYNE, IN, 46802, US

(21) Appl. No.: 11/001,742

(22) Filed: Dec. 2, 2004

(51) Int. Cl. A01L 5/00

(52) U.S. Cl. 168/4

(57) ABSTRACT

A composite horseshoe having a rigid base member and a resilient member disposed within a groove formed in the base member. The resilient member is bonded to the base member by a layer of adhesive having a substantially consistent thickness. The consistent thickness of the adhesive layer can be obtained by the use of spacing elements such as glass beads. The resilient member may be a rubber insert and be formed out of an automobile tire or by molding a rubber compound.

### BACKGROUND OF THE INVENTION

1. Field of the Invention

The present invention relates to horseshoes and, more particularly, composite horseshoes having a substrate and a resilient layer.

2. Description of the Related Art

Horseshoes are used to protect the hooves of a horse and many forms of horseshoes have been developed over the years. Oftentimes, the design of a horseshoe involves tradeoffs between competing attributes. For example, it is generally desirable to provide a horseshoe having a lightweight. It also desirable to provide a horseshoe that dampens the impact between the horse hoof and the ground. Furthermore, a horseshoe should be rugged and be able to withstand the forces generated during use without excessive damage or wear to the horseshoe. One known approach to balancing these competing attributes it to provide a composite horseshoe that combines a rigid metallic material to provide strength to the horseshoe with a resilient material for dampening impact forces. A perennial difficulty with such composite horseshoes is that the attachment between the resilient material and the more rigid material is subject to failure during use. Providing a secure and reliable connection between the two materials often requires relatively complex or expensive manufacturing techniques. A rugged composite horseshoe that can be easily and cost-effectively manufactured is desirable.

### SUMMARY OF THE INVENTION

The present invention provides a horseshoe having rigid base material with a resilient insert to provide a lightweight and durable horseshoe that can be easily and cost-effectively manufactured.

The invention comprises, in one form thereof, a horseshoe for mounting on a horse hoof that includes a base member and a resilient member. A plurality of spacing elements separate the resilient member from the base member and an adhesive surrounds the spacing elements and bonds the resilient member to the base member.

The invention comprises, in another form thereof, a horseshoe that includes a substantially U-shaped base member and a resilient insert member. The base member has a first substantially planar surface adapted to face the horse hoof and a second surface disposed opposite the first surface. The second surface defines an opening to a groove and the resilient member is disposed in the groove and extends outwardly therefrom to thereby define a ground engaging surface of the horseshoe. The horseshoe also includes an adhesive layer disposed in the groove between the base member and the resilient member and which bonds the resilient member to the base member.

The invention comprises, in yet another form thereof, a horseshoe that includes a substantially U-shaped base member and a resilient member. The base member has a first substantially planar surface adapted to face the horse hoof and a second surface disposed opposite the first surface. The second surface defines an opening to a groove. The resilient member is disposed in the groove and extends outwardly therefrom to thereby define a ground engaging surface of the horseshoe. An adhesive layer is disposed in the groove between the base member and the resilient member and bonds the resilient member to the base member. The adhesive layer has a substantially consistent predefined thickness.

The invention comprises, in still another form thereof, a method of manufacturing a horseshoe. The method includes providing a base member having a first substantially planar surface and an oppositely disposed second surface wherein the second surface defines an opening to a groove. A resilient member shaped to fit within the groove is provided and is placed in the groove with an adhesive between the resilient member and the base member. The method also includes pressing the resilient member into the groove.

An advantage of the present invention is that can be used to provide an adhesive layer of consistent thickness between the resilient insert and the base member whereby the resilient insert can be reliably and securely adhered to the base member.

Another advantage of the present invention is that by providing a secure adhesive bond between the resilient insert and the base member no mechanical attachment of the insert to the base member is required thereby facilitating the efficient manufacture of the horseshoe.

### BRIEF DESCRIPTION OF THE DRAWINGS

The above mentioned and other features and objects of this invention, and the manner of attaining them, will become more apparent and the invention itself will be better understood by reference to the following description of the invention taken in conjunction with the accompanying drawings, wherein:

FIG. 1 is a schematic exploded view of a horse hoof and a horseshoe in accordance with the present invention.

FIG. 2 is a bottom view of the horseshoe of FIG. 1.

FIG. 3 is a side view of the horseshoe of FIG. 1.

FIG. 4 is a cross sectional view taken along line 4-4 of FIG. 2.

FIG. 5 is a bottom view of the base layer of the horseshoe of FIG. 1.

FIG. 6 is a cross sectional view of the horseshoe of FIG. 1 prior to attachment of the resilient insert to the rigid base layer.

Corresponding reference characters indicate corresponding parts throughout the several views. Although the exemplification set out herein illustrates an embodiment of the invention, the embodiments disclosed below are not intended to be exhaustive or to be construed as limiting the scope of the invention to the precise forms disclosed.

### DETAILED DESCRIPTION OF THE INVENTION

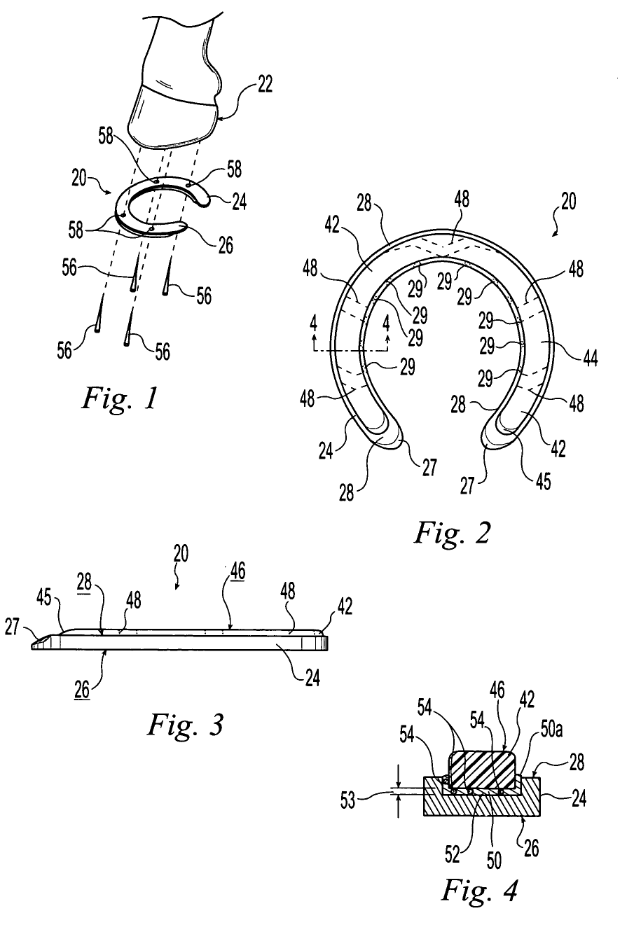

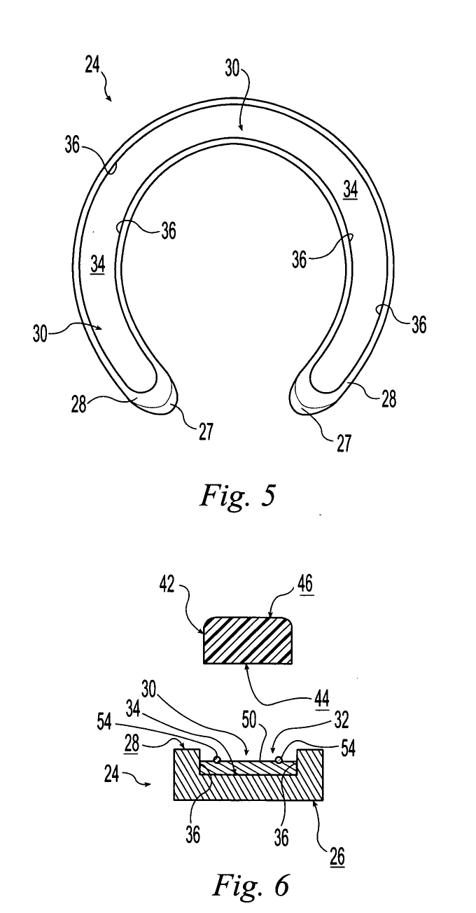

A horseshoe 20 in accordance with the present invention is show in FIG. 1 and is adapted to be attached to the bottom of horse hoof 22. Horseshoe 20 is illustrated in greater detail in FIGS. 2-6 and includes a rigid base member 24 and a resilient member or insert 42. Base member 24 is a rigid, relatively strong material and may be formed out of a metallic material. For example, base member 24 can be steel (e.g., 10/10 or 10/18 steel), or, for a lighter weight shoe, it can be formed of aluminum (e.g., 60/61 or 20/24 aluminum). In the illustrated embodiment, base member 24 is a forged aluminum material. Base member 24 has a generally U-shaped configuration with a first substantially planar surface 26 and an opposite second major surface 28. First surface 26 is adapted to face and engage horse hoof 22 while second surface 28 forms an exposed exterior surface of shoe 20 and faces toward the ground after shoe 20 has been attached to hoof 22.

A U-shaped groove 30 is located in second surface 28. Groove 30 includes a bottom wall 34 and sidewalls 36. Sidewalls 36 extend between bottom wall 34 and surface 28 and define an opening 32 in surface 28. Sidewalls 36 are positioned perpendicular to both bottom wall 34 and surface 28 so that opening 32 and bottom wall 34 have an area and configuration that are substantially identical.

When mounting shoe 20 to a hoof 22, base member 24 may have to be bent to conform to the shape of the hoof to which it is being attached. Dashed lines 29 represent the location of optional semi-circular notches along the interior perimeter of U-shaped base member 24 that can be used to allow base member 24 to be more easily bent to the desired shape. Such notches, however, are not utilized in the illustrated embodiment.

Resilient member 42 is bonded to base member 24 within groove 30. As seen in FIG. 2, resilient member 42 has a generally U-shaped configuration that conforms to the size and shape of groove 30. More specifically, resilient member 42 generally conforms to the size and shape of bottom wall 34 and opening 32. Resilient member 42 has a first surface 44 that faces bottom wall 34 of groove 30 and an opposite second surface 46 that engages the ground when shoe 20 is mounted on hoof 22.

In the illustrated embodiment, resilient member 42 is formed of a rubber compound and may be manufactured by stamping an appropriately shaped part out of an automobile tire, preferably without plies or with the plies removed, or by compression molding an insert having the desired shape using a rubber compound having a composition similar to that of an automobile tire. If resilient member 42 is manufactured using steel belt tires, the steel belts/plies within the tires are removed before the tires are stamped to form resilient members 42. Steel belts can be efficiently removed from the tires by placing a tire, or a part of a tire, in an induction coil and energizing the coil. By passing electricity through a wire coil, i.e., energizing the induction coil, an electromagnetic field will be generated. Placing the tire within this electromagnetic field will generate an electrical current in the steel belts located within the tire. The electrical resistance of the steel belts will cause the steel belts to heat as they conduct electricity. The heat will, in turn, heat and soften the tire rubber in immediate contact with the steel belts and thereby allow the steel belts to be more easily removed from the tire.

When tires are used to form resilient members 42, one of the exterior surfaces of resilient member 42 may have tire treads. If tire treads are present on resilient member 42, the treads will be positioned to form the ground engaging surface 46 of resilient member 42. Dashed lines 48 in FIGS. 2 and 3 schematically represent the presence of such tire treads.

As seen in FIG. 4, adhesive layer 50 bonds resilient member 42 to base member 24. Sidewalls 36 frictionally engage the sides of resilient member 42 but this frictional engagement is minimal in comparison to the bond formed by adhesive layer 50. Consequently, sidewalls 36 do not mechanically capture resilient member 42 within groove 30. The adhesive used to bond resilient member 42 to base member 24 may be any adhesive suitable for the combination of materials being bonded together. A variety elastomer bonding adhesives are commercially available and, preferably, a two part epoxy, is well suited and is used for adhering a rubber insert 42 to an aluminum base member 24 and is the adhesive used in the illustrated embodiment.

Prior to adhering resilient member 42 to base member 24, resilient member 42 is cleaned and primed. Resilient member 42, which in the illustrated embodiment is a rubber insert, is first cleaned with a solvent, such as alcohol. Cleaning with a solvent will promote adherence to base member 24. After cleaning, a primer is applied to surface 44. To prepare groove 30 for bonding to resilient member 42, bottom wall 34 and sidewalls 36 are sandblasted for removing any oxidation thereon.

Adhesive 50 is placed in groove 30 and spacing elements 54 sprinkled on adhesive 50 before resilient member 42 is pressed into groove 30. Alternatively, spacing elements could be mixed into adhesive 50 prior to applying the adhesive. Spacing elements 54 are substantially spherically shaped glass beads having a diameter of approximately 1 millimeter. Spacing elements 54 are not shown to scale in FIGS. 4 and 6 but instead have been enlarged relative to the other parts of shoe 20 for purposes of graphical clarity. Spacing elements 54 position resilient member 42 at a predefined distance 53 (FIG. 4) from bottom wall 34 and/or sidewalls 36 as resilient member 42 is pressed into groove 30 and during the curing of adhesive layer 50. This prevents surface 44 of resilient member 42 from directly engaging bottom wall 34 and/or sidewalls 36 and defines a volume or void space 52 between resilient member 42 and bottom wall 34 and/or sidewalls 36 that has a substantially consistent thickness. As a result, the adhesive layer 50 which fills volume 52 has a substantially consistent and predefined thickness equal to distance 53.

Without the use of glass beads or similar spacing elements 54, the pressing of resilient member 42 into groove 30 would result in areas where surface 44 of resilient member 42 directly engaged bottom wall 34 and/or sidewalls 36 of groove 30. In these areas of direct engagement, the adhesive layer 50 would be minimal or nonexistent and the bonding of resilient member 42 to bottom wall 34 at these locations would, as a result, be poor or nonexistent. During use, these zones of weak or non-existent bonding between resilient member 42 and bottom wall 34 could enlarge and precipitate the premature failure of the bond between resilient member 42 and base member 24. The use of spacing elements 54 provides adhesive layer 50 with a desired and consistent thickness and the resulting bond between resilient member 42 and bottom wall 34 and/or sidewalls 36 does not include the weak zones that result from direct contact between surface 44 of resilient member 42 and bottom wall 34 and/or sidewalls 36. Although spacing elements 54 also define points where adhesive layer 50 is subject to a discontinuity, the area of spacing elements 54 is quite minimal in comparison to the overall surface area of bottom wall 34 and/or sidewalls 36 and does not significantly impact the strength of the bond between resilient member 42 and bottom wall 34 and/or sidewalls 36.

Although glass beads are used in the illustrated embodiment, alternative spacing elements can also be employed with the present invention. Furthermore, the spacing elements could be integrally formed on base member 24 or insert 42. The complexity and resulting cost of such integral spacing elements, however, would likely be significantly greater than the use of separate discrete spacing elements as shown in the illustrated embodiment.

As resilient member 42 is pressed into groove 30, the total quantity of adhesive located in groove 30 will likely exceed the volume of void space 52 defined between resilient member 42 and some excess adhesive 50a will escape between resilient member 42 and a portion of sidewall 36 as depicted in FIG. 4. Spacing elements 54 may also be transported upwardly with excess adhesive 50a and can thereby also provide another relatively consistent layer of adhesive between resilient member 42 and sidewalls 36. Resilient member 42 is clamped in place as adhesive 50 cures. The curing of adhesive 50 may be done at room temperature, in which case it will take approximately 24 hours. Alternatively, shoe 20 may be placed in an oven at 300° F. (148.9° C.) for between 5 and 15 minutes to provide for the more rapid curing of adhesive 50.

After curing adhesive 50, shoe 20 may be attached to hoof 22 in any one of the various manners of securing horseshoes that are well known in the art. For example, shoe 20 could be attached to hoof 22 using an adhesive. Alternatively, holes 58 may be drilled through shoe 20 and fasteners 56, e.g. nails, driven through holes 58 into hoof 22 as schematically depicted in FIG. 1. When holes 58 are drilled through resilient member 42 and bottom wall 34, the head of fasteners 56 will be seated directly against bottom wall 34 to firmly secure shoe 20 to hoof 22.

As can be seen in FIGS. 2 and 3, base member 24 defines a slanted shoulder 27 at the two ends of its U-shaped configuration. Similarly, resilient member 42 defines slanted shoulders 45 at its two ends. These shoulders are not required but such shoulders are often utilized on racing horseshoes to minimize the possibility that these edges will inadvertently catch on the ground when the horse is running as is well known to those having ordinary skill in the art.

While this invention has been described as having an exemplary design, the present invention may be further modified within the spirit and scope of this disclosure. This application is therefore intended to cover any variations, uses, or adaptations of the invention using its general principles.

What is claimed is:

1. A horseshoe for mounting on a horse hoof, said horseshoe comprising:
a base member;
a resilient member;
a plurality of spacing elements separating said resilient member and said base member; and
an adhesive surrounding said spacing elements and bonding said resilient member to said base member.

2. The horseshoe of claim 1 wherein said base member includes a first substantially planar surface adapted to face the horse hoof and a second surface disposed opposite said first surface, said second surface defining an opening to a groove and wherein said plurality of spacing elements, said adhesive and at least a portion of said resilient member are disposed within said groove.

3. The horseshoe of claim 1 wherein said spacing elements separate said base member and said resilient member by a predefined distance.

4. The horseshoe of claim 3 wherein said adhesive forms a layer having a consistent thickness substantially equal to said predefined distance.

5. The horseshoe of claim 1 wherein said spacing elements have a substantially spherical shape.

6. The horseshoe of claim 5 wherein said spacing elements are glass beads.

7. A horseshoe for mounting on a horse hoof, said horse shoe comprising:
a substantially U-shaped base member, said base member having a first substantially planar surface adapted to face the horse hoof and a second surface disposed opposite said first surface, said second surface defining an opening to a groove;
a resilient member disposed in said groove and extending outwardly therefrom to thereby define a ground engaging surface of said horseshoe; and
an adhesive layer disposed in said groove between said base member and said resilient member, said adhesive layer bonding said resilient member to said base member.

8. The horseshoe of claim 7 wherein said base member comprises a metallic material.

9. The horseshoe of claim 8 wherein said base member comprises an aluminum material.

10. The horseshoe of claim 9 wherein said resilient member comprises a rubber material.

11. The horseshoe of claim 7 wherein said second surface defines an exposed exterior surface of said horseshoe and said groove is defined by a bottom wall and sidewalls extending between said bottom wall and said second surface, said sidewalls allowing unrestricted movement of said resilient member outwardly from said groove through said opening whereby said resilient member is uncaptured mechanically within said groove by said sidewalls.

12. The horseshoe of claim 11 wherein said sidewalls are substantially perpendicular to said bottom wall and said opening in said second surface has a configuration and area substantially equal to that of said bottom wall.

13. The horseshoe of claim 7 further comprising a plurality of spacing elements disposed between said resilient member and said base member, said spacing elements positioning said resilient member at a predefined distance from said base member, and said adhesive layer filling a volume between said base member and said resilient member.

14. The horseshoe of claim 13 wherein said spacing elements are glass beads having a predefined diameter.

15. The horseshoe of claim 7 wherein said resilient member comprises a portion of a tire.

16. A horseshoe for mounting on a horse hoof, said horseshoe comprising:
a substantially U-shaped base member, said base member having a first substantially planar surface adapted to face the horse hoof and a second surface disposed opposite said first surface, said second surface defining an opening to a groove;
a resilient member disposed in said groove and extending outwardly therefrom to thereby define a ground engaging surface of said horseshoe; and
an adhesive layer disposed in said groove between said base member and said resilient member, said adhesive layer bonding said resilient member to said base member and wherein said adhesive layer has a substantially consistent predefined thickness.

17. The horseshoe of claim 16 wherein said base member comprises a metallic material.

18. The horseshoe of claim 17 wherein said base member comprises an aluminum material.

19. The horseshoe of claim 18 wherein said resilient member comprises a rubber material.

20. The horseshoe of claim 16 wherein said second surface is an exposed exterior surface of said horseshoe, said groove being defined by a bottom wall and sidewalls extending between said bottom wall and said opening in said second surface.

21. The horseshoe of claim 20 wherein said sidewalls are substantially perpendicular to said bottom wall and said opening in said second surface has a configuration and area substantially equal to that of said bottom wall.

22. The horseshoe of claim 16 further comprising a plurality of spacing elements disposed between said resilient member and said base member, said spacing elements positioning said resilient member at a predefined distance from said base member, said adhesive layer filling a volume between said base member and said resilient member and said predefined distance being substantially equal to said predefined thickness.

23. The horseshoe of claim 22 wherein said spacing elements are glass beads having a predefined diameter.

24. The horseshoe of claim 16 wherein said resilient member comprises a portion of a tire.

25. A method of manufacturing a horseshoe, said method comprising:
providing a base member having a first substantially planar surface and an oppositely disposed second surface wherein the second surface defines an opening to a groove;
providing a resilient member shaped to fit within the groove;
placing the resilient member in the groove with an adhesive between the resilient member and the base member; and
pressing the resilient member into the groove.

26. The method of claim 25 wherein the step of pressing the resilient member into the groove includes forming an adhesive layer between the base member and the resilient member wherein the layer has a substantially consistent and predefined thickness.

27. The method of claim 25 wherein the resilient member is spaced from the base member by a plurality of spacing elements positioned between the base member and the resilient member during said step of pressing the resilient member into the groove.

28. The method of claim 27 wherein the adhesive and spacing elements are positioned in the groove before the resilient member is placed in the groove and wherein the spacing elements position the resilient member at a predefined distance from the base member as the resilient member is pressed into the groove.

29. The method of claim 27 wherein the spacing elements have a spherical shape.

30. The method of claim 29 wherein the spacing elements are glass beads.

31. The method of claim 25 wherein the resilient member comprises a rubber material and said base member comprises a metallic material.

32. The method of claim 31 wherein the base member comprises aluminum and is formed by forging.

33. The method of claim 25 wherein the step of providing the resilient member includes forming the resilient member from a portion of a tire.

34. The method of claim 25 wherein the step of providing the resilient member includes forming the resilient member by molding a rubber material.
